(19) United States
(12) Patent Application Publication
(10) Pub. No.: US 2026/0058772 A1
(43) Pub. Date: Feb. 26, 2026

(54) CYCLIC DELAY VALUE REPORTING

(71) Applicant: QUALCOMM Incorporated, San Diego, CA (US)

(72) Inventors: Kangqi LIU, San Diego, CA (US); Hyojin LEE, San Diego, CA (US); Weimin DUAN, San Diego, CA (US)

(21) Appl. No.: 18/811,290

(22) Filed: Aug. 21, 2024

(51) Int. Cl. H04L 5/00; H04W 28/18; H04W 72/21; H04W 72/23

(52) U.S. Cl. CPC H04L 5/0048; H04W 28/18; H04W 72/21; H04W 72/23

(57) ABSTRACT

Methods, systems, and devices for wireless communications are described. In some examples, a user equipment (UE) may receive control signaling allocating one or more uplink resources. The UE may transmit an indication of one or more cyclic delay values in accordance with receiving the control signaling, where each cyclic delay value of the one or more cyclic delay values may correspond to a delay between one or more instances of a signal, where each instance of the signal may be transmitted via a respective antenna at the UE. The UE may transmit one or more uplink signals in accordance with the one or more cyclic delay values, in accordance with the control signaling, or both.

### FIELD OF TECHNOLOGY

The following relates to wireless communications, including cyclic delay value reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a user equipment (UE) is described. The method may include receiving control signaling allocating one or more uplink resources, transmitting an indication of one or more cyclic delay values in accordance with receiving the control signaling, where each cyclic delay value of the one or more cyclic delay values corresponds to a delay between one or more instances of a signal, each instance of the signal transmitted via a respective antenna at the UE, and transmitting one or more uplink signals in accordance with the one or more cyclic delay values, in accordance with the control signaling, or both.

A UE for wireless communication is described. The UE may include one or more memories storing processor executable code, and one or more processors coupled with the one or more memories. The one or more processors may individually or collectively be operable to execute the code to cause the UE to receive control signaling allocating one or more uplink resources, transmit an indication of one or more cyclic delay values in accordance with receiving the control signaling, where each cyclic delay value of the one or more cyclic delay values corresponds to a delay between one or more instances of a signal, each instance of the signal transmitted via a respective antenna at the UE, and transmit one or more uplink signals in accordance with the one or more cyclic delay values, in accordance with the control signaling, or both.

Another UE for wireless communication is described. The UE may include means for receiving control signaling allocating one or more uplink resources, means for transmitting an indication of one or more cyclic delay values in accordance with receiving the control signaling, where each cyclic delay value of the one or more cyclic delay values corresponds to a delay between one or more instances of a signal, each instance of the signal transmitted via a respective antenna at the UE, and means for transmitting one or more uplink signals in accordance with the one or more cyclic delay values, in accordance with the control signaling, or both.

A non-transitory computer-readable medium storing code for wireless communication is described. The code may include instructions executable by one or more processors to receive control signaling allocating one or more uplink resources, transmit an indication of one or more cyclic delay values in accordance with receiving the control signaling, where each cyclic delay value of the one or more cyclic delay values corresponds to a delay between one or more instances of a signal, each instance of the signal transmitted via a respective antenna at the UE, and transmit one or more uplink signals in accordance with the one or more cyclic delay values, in accordance with the control signaling, or both.

In some examples of the method, UEs, and non-transitory computer-readable medium described herein, the control signaling allocates one or more sounding reference signal (SRS) resources and each of the one or more SRS resources may be associated with a respective modulation and coding scheme (MCS), a respective bandwidth, or both.

In some examples of the method, UEs, and non-transitory computer-readable medium described herein, transmitting the indication may include operations, features, means, or instructions for transmitting one or more SRSs via the one or more SRS resources, where each of the one or more SRSs may be transmitted according to a respective cyclic delay value of the one or more cyclic delay values.

Some examples of the method, UEs, and non-transitory computer-readable medium described herein may further include operations, features, means, or instructions for receiving second control signaling activating or deactivating at least one SRS resource of the one or more SRS resources, where transmitting the indication of the one or more cyclic delay values may be in accordance with the activation or the deactivation.

Some examples of the method, UEs, and non-transitory computer-readable medium described herein may further include operations, features, means, or instructions for receiving second control signaling overriding at least one SRS resource of the one or more SRS resources, where transmitting the indication of the one or more cyclic delay values may be in accordance with overriding the at least one SRS resource.

In some examples of the method, UEs, and non-transitory computer-readable medium described herein, each cyclic delay value of the one or more cyclic delay values may be associated with the respective MCS, the respective bandwidth, or both.

In some examples of the method, UEs, and non-transitory computer-readable medium described herein, at least one cycle delay value of the one or more cyclic delay values may be associated with respective channel quality information for at least one SRS resource of the one or more SRS resources in accordance with an absence of an indication of a MCS for the at least one SRS resource.

In some examples of the method, UEs, and non-transitory computer-readable medium described herein, receiving the control signaling may include operations, features, means, or instructions for receiving downlink control information (DCI) allocating the one or more uplink resources and requesting transmission of the one or more cyclic delay values, where transmitting the indication of the one or more cyclic delay values may be in accordance with receiving the DCI.

In some examples of the method, UEs, and non-transitory computer-readable medium described herein, the DCI further indicates one or more MCSs, one or more bandwidths, or both associated with the one or more uplink resources and each cyclic delay value of the one or more cyclic delay values may be associated with a respective MCS, a respective bandwidth, or both.

In some examples of the method, UEs, and non-transitory computer-readable medium described herein, transmitting the indication may include operations, features, means, or instructions for transmitting a report indicating the one or more cyclic delay values via a physical uplink control channel (PUCCH) or via a media access control-control element (MAC-CE).

Some examples of the method, UEs, and non-transitory computer-readable medium described herein may further include operations, features, means, or instructions for transmitting a scheduling request (SR) requesting to update the one or more cyclic delay values in accordance with transmitting the indication of the one or more cyclic delay values, receiving second control signaling, the second control signaling allocating one or more second one or more uplink resources, and transmitting a second indication of the one or more updated cyclic delay values in accordance with the one or more second one or more uplink resources.

Some examples of the method, UEs, and non-transitory computer-readable medium described herein may further include operations, features, means, or instructions for receiving, in accordance with transmitting the indication, second control signaling requesting an update to the one or more cyclic delay values and transmitting, via an aperiodic PUCCH, the one or more updated cyclic delay values.

Some examples of the method, UEs, and non-transitory computer-readable medium described herein may further include operations, features, means, or instructions for transmitting the one or more uplink signals may be after a first duration from transmitting the indication of the one or more cyclic delay values.

In some examples of the method, UEs, and non-transitory computer-readable medium described herein, the one or more uplink signals include a PUCCH or a physical uplink shared channel (PUSCH).

In some examples of the method, UEs, and non-transitory computer-readable medium described herein, the one or more cyclic delay values include one or more small delay cyclic delay diversity values and each small delay cyclic diversity value of the one or more small delay cyclic delay diversity values satisfies a threshold.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support cyclic delay value reporting in accordance with one or more aspects of the present disclosure.

FIGS. 3, 4A, and 4B show examples of process flows that support cyclic delay value reporting in accordance with one or more aspects of the present disclosure.

FIGS. 5, 6A, and 6B show examples of timing diagrams that support cyclic delay value reporting in accordance with one or more aspects of the present disclosure.

FIGS. 7 and 8 show block diagrams of devices that support cyclic delay value reporting in accordance with one or more aspects of the present disclosure.

FIG. 9 shows a block diagram of a communications manager that supports cyclic delay value reporting in accordance with one or more aspects of the present disclosure.

FIG. 10 shows a diagram of a system including a device that supports cyclic delay value reporting in accordance with one or more aspects of the present disclosure.

FIGS. 11 through 13 show flowcharts illustrating methods that support cyclic delay value reporting in accordance with one or more aspects of the present disclosure.

### DETAILED DESCRIPTION

Some wireless communications systems may support diversity schemes, in which a first device (e.g., a transmitting device, user equipment (UE), network entity) may transmit a message via multiple signal paths to a second device (e.g., receiving device, a network entity, a UE) to improve signal quality and reliability. In some cases, the first device (e.g., a network entity, a UE) may use a cycle delay diversity (CDD) scheme to transmit signaling. In the CDD scheme, the first device may apply a cyclic delay for each transmit antenna. For example, the first device may transmit multiple instances of data via respective antennas, where each instance (e.g., copy) of the data that is delayed from a previous instance by a CDD value (e.g., cyclic delay value). In such CDD schemes, to accurately perform channel measurements and perform channel decoding, the second device may utilize the CDD value. However, in such cases, the second device may not be provided or may have no indication of the CDD value utilized at the first device, nor have an indication of whether the first device used the CDD scheme. As such, the second device may not be able to accurately perform channel decoding and measurements, which may lead to a degradation in channel quality and service, among other disadvantages.

The techniques described herein may support a UE (e.g., a first device) using a small delay CDD (SD-CDD) scheme for uplink transmissions and support the UE indicating or reporting one or more SD-CDD values (e.g., cyclic delay values) to a network entity (e.g., a receiving device), such that the network entity may obtain accurate channel measurements and perform channel decoding. For example, the UE may receive control signaling that allocates uplink resources. In some examples, the control signaling may allocate sounding reference signal (SRS) resources. In such examples, the UE may calculate the SD-CDD value for each SRS resource based on a modulation and coding scheme (MCS) allocated for each SRS resource, a bandwidth part allocated for each SRS resource, or both. Based on calculating the SD-CDD value for each SRS resource, the UE may transmit a respective SRS in each SRS resource according to a respective SD-CDD value. The network entity may receive and perform channel measurements, such as PDP measurements, using each SRS. By performing the channel measurements on the SRSs transmitted according to different SD-CDD values, the network entity may obtain channel measurements for signals associated with the different SD-CDD values, thereby enabling the network entity to account for the SD-CDD value within channel measurements (e.g., without explicit knowledge of the SD-CDD value).

In some other examples, the control signaling may include an uplink grant allocating one or more uplink resources for one or more physical uplink shared channel (PUSCH) transmissions. In such examples, the UE may determine one or more SD-CDD values corresponding to the allocated uplink resources based on a MCS associated with each PUSCH transmission, a bandwidth part associated with each PUSCH transmission, or both. Based on determining the one or more SD-CDD values, the UE may transmit a report indicating the one or more SD-CDD values, where the network entity may use the report to perform accurate channel estimation and receive the one or more PUSCH transmissions.

By indicating the SD-CDD values to the network entity, either via implicit signaling (e.g., via the SRSs) or explicit signaling (e.g., via the report), the network entity may utilize the indications to obtain accurate channel measurements, thereby increasing reliability in wireless communications. Additionally, by implementing the signaling schemes (e.g., SRS or report scheme), the UE and the network entity may experience improved coordination, thereby reducing the likelihood of communication failures.

Aspects of the disclosure are initially described in the context of wireless communications systems, process flows, and timing diagrams. Aspects of the disclosure are further illustrated by and described with reference to apparatus diagrams, system diagrams, and flowcharts that relate to cyclic delay value reporting.

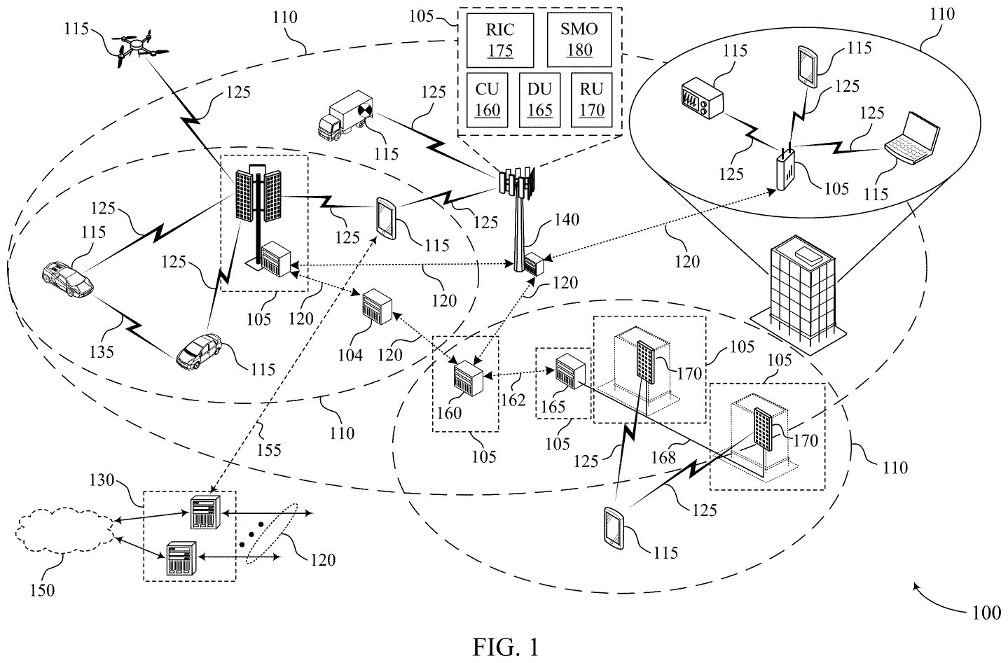

FIG. 1 shows an example of a wireless communications system 100 that supports cyclic delay value reporting in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogencous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communications systems may support diversity schemes, in which a message may be transmitted via multiple signal paths to a receiving device, to improve signal quality and reliability. Diversity schemes may be implemented to broadcast data and to transmit or receive information or messages via control channels. Diversity schemes may also be implemented before an RRC connection is established, and may also be implemented (e.g., as a fallback) in the case of unreliable channel state information (CSI) feedback, including high speed cases. An efficient diversity scheme may have a good performance (e.g., diversity order), a small demodulation reference signal (DMRS) overhead, and a transmission scheme that may be aligned with DMRS transmission, which may simply interference estimation.

In some implementations, a diversity scheme may be based on space frequency block coding (SFBC). An SFBC diversity scheme may be implemented in 2-port MIMO devices (e.g., 2-port DMRS may be implemented). In some cases, the two ports may be two different or separate antennas, antenna panels, polarizations (POL), or beams (e.g., in the case of massive MIMO). For example, based on spacing between antennas and frequency separation between subcarriers, a block of data may be coded for transmission diversity. Each beam transmitted from a port, POL, antenna, or panel may be transmitted with a diversity scheme determined by antenna spacing and a subcarrier separation (e.g., a frequency difference). However, in some implementations (e.g., NR channels), an SFBC diversity scheme may not be supported. For example, in an SFBC scheme, wireless devices (e.g., the UE 115, the network entity 105) may utilize two antenna ports to transmit a single layer, which may not be supported at some devices. That is, some device may be single port devices, and in some cases, the single port may support multiple antennas or antenna panels. In some cases, multi-layer session management (SM) transmission may be used for achieving a high spectral efficiency, which may be desired in some implementations (e.g., NR). A multiple transmission scheme, such as an SFBC diversity scheme, and any inconsistency between a data signal and DMRS transmission may complicate implementation at a UE, increasing the complexity at the UE, and may limit viable applications of an interference-aware advanced receiver.

The wireless communications systems 100 may support diversity schemes, in which a message may be transmitted via multiple signal paths to a receiving device (e.g., a network entity 105, a UE 115) to improve signal quality and reliability. In some cases, a transmitting device (e.g., a network entity 105, a UE 115) may use a CDD value (e.g., cyclic delay value) to transmit signaling. In a CDD scheme, the transmitting device may apply a delay for each transmit antenna. For example, the transmitting device may transmit data over multiple different antennas, where each instance (e.g., copy) of the data that is transmitted via a respective antenna may be delayed by the CDD value. In such CDD schemes, to accurately perform channel measurements and channel decoding, the receiving device may have to utilize the CDD value.

However, in some systems, the receiving device may not be provided or may have no indication of the CDD value (e.g., cyclic delay value) utilized at the transmitting device, or if the CDD value was used by the transmitting device. In the case of a single port transmitting device, the receiving device also may not be able to distinguish between specific antennas or antenna panels at a port. That is, the receiving device may receive signals from the transmitting device as coming from one port, but may have no further information or granularity related to the signals. As such, the receiving device may not be able to accurately perform channel decoding and measurements without some indication of the SD-CDD value, which may lead to a degradation in channel quality and service, among other disadvantages.

The techniques described herein may support a UE 115 (e.g., a transmitting device) using a SD-CDD scheme for uplink transmissions and support the UE 115 indicating or reporting one or more SD-CDD values (e.g., cyclic delay values) to a network entity 105 (e.g., a receiving device), such that the network entity 105 may obtain accurate channel measurements on signals transmitted using the SD-CDD scheme. For example, the UE 115 may receive control signaling that allocates uplink resources. In some examples, the control signaling may allocate SRS resources. In such examples, the UE 115 may calculate the SD-CDD value for each SRS resource based on a MCS allocated for each SRS resource, a bandwidth part allocated for each SRS resource, or both. Based on calculating the SD-CDD value for each SRS resource, the UE 115 may transmit a respective SRS in each SRS resource according to a respective SD-CDD value. The network entity 105 may receive and perform channel measurements, such as PDP measurements, using each SRS. By performing the channel measurements on the SRSs transmitted according to different SD-CDD values, the network entity 105 may obtain channel measurements for signals associated with the different SD-CDD values, thereby enabling the network entity to account for the SD-CDD value within channel measurements (e.g., without explicit knowledge of the SD-CDD value).

In some other examples, the control signaling may include an uplink grant allocating one or more uplink resources for one or more PUSCH transmissions. In such examples, the UE 115 may determine one or more SD-CDD values corresponding to the allocated uplink resources based on a MCS associated with each PUSCH transmission, a bandwidth part associated with each PUSCH transmission, or both. Based on determining the one or more SD-CDD values, the UE 115 may transmit a report indicating the one or more SD-CDD values, where the network entity may use the report to perform accurate channel estimation and receive the one or more PUSCH transmissions.

By indicating the SD-CDD values to the network entity 105, either via implicit signaling (e.g., via the SRSs) or explicit signaling (e.g., via the report), the network entity 105 may utilize the indications to obtain accurate channel measurements, thereby increasing reliability in wireless communications. Additionally, by implementing the signaling schemes (e.g., SRS or report scheme), the UE 115 and the network entity 105 may experience improved coordination, thereby reducing the likelihood of communication failures.

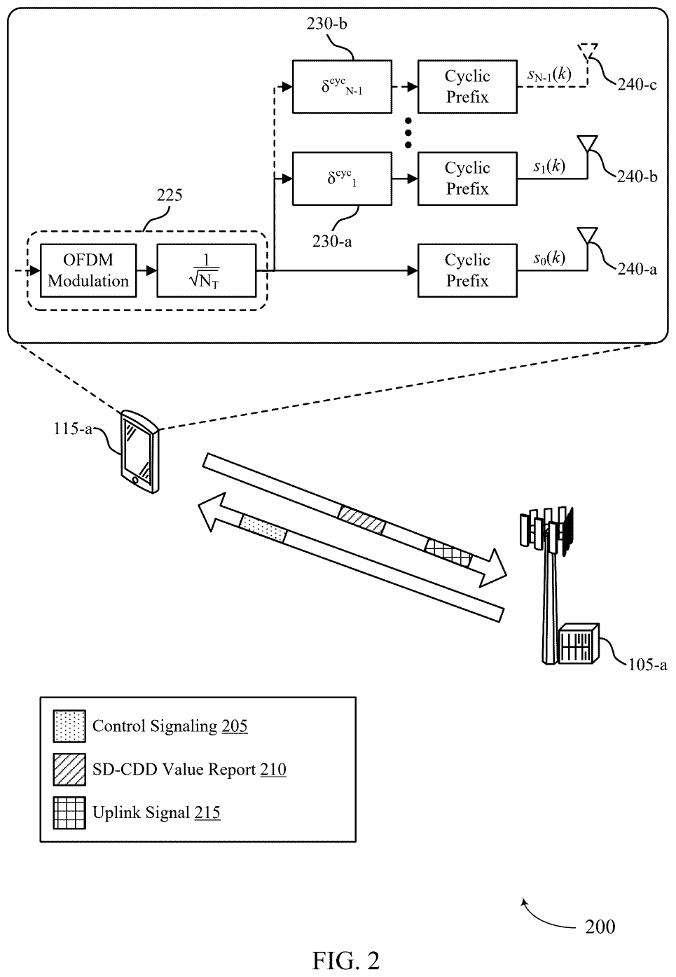

FIG. 2 shows an example of a wireless communications system 200 that supports cyclic delay value reporting in accordance with one or more aspects of the present disclosure. In some examples, aspects of the wireless communications system 200 may implement, or be implemented by, aspects of the wireless communications system 100. For example, the wireless communications system 200 may include a UE 115-a and a network entity 105-a, which may be examples of the corresponding devices as described herein, including with reference to FIG. 1. The techniques described in the context of the wireless communications system 200 may support methods for a UE 115-a to report cyclic delay values (e.g., SD-CDD values) to a network entity 105-a.

In some cases, the network entity 105-a may transmit control signaling 205 to the UE 115-a, where the control signaling 205 may allocate uplink resources that the UE 115-a may use to implement a CDD scheme. Implementing the CDD scheme at the UE 115-a may include transmitting one or more instances of the uplink signal 215 via multiple antennas 240 (e.g., or multiple groups of antennas, antenna panels, receivers, ports). For example, at 225, the UE 115-a may perform one or more operations to form an uplink signal (e.g., represented as s(k)), where the one or more operations may include OFDM modulation (e.g., \tilde{s}(k)) and application of a modifier (e.g.,

$$\frac{1}{\sqrt{{N}_{T}}} ,$$

a scaling constant, where NT may be a quantity of antennas 240 or groups of the antennas 240 used to transmit the instances of the uplink signal 215).

The UE 115-a may send the instances of the uplink signal 215 (s (k) (or \tilde{s} (k))) to one or more transmission circuits, which may add a cyclic delay δ(e.g., the CDD parameter), and may add a cyclic prefix to the instances of the uplink signal 215 before transmitting an uplink signal 215 of the instances of the uplink signal 215 with a respective cyclic delay and a cyclic prefix via a respective antenna 240 (e.g., or group of antennas).

For example, according to the CDD scheme, the UE 115-a may apply no cyclic delay to the instance of the uplink signal 215 transmitted by an antenna 240-a, may apply the cyclic delay 230-a

$$( e . g . , {δ}_{1}^{cyc} )$$

for transmission or a second instance of the uplink signal 215 by an antenna 240-b, and so forth, until adding a cyclic delay 230-b

$$( e . g . , of {δ}_{{N}_{T} - 1}^{cyc} )$$

for an antenna 240-c. That is, the UE 115-a may modify and send the instances of the uplink signal 215 (e.g., s (k)) from each antenna 240 (e.g., via respective resource elements) as so (k), S1 (k), and so forth until S_{N}_{_{T}}₋₁ (k), where each signal s; (k) is associated with an increasing respective cyclic delay δ(e.g., a phase shift 8) that is a multiple of the value of the CDD parameter.

As an illustrative example, the UE 115-a may apply no cyclic delay to a first instance of the uplink signal 215 for the antenna 240-a, apply the cyclic delay 230-a (e.g., cyclic delay * 1) to a second instance of the uplink signal 215 for the antenna 240-a, apply the cyclic delay 230-b (e.g., a multiple of the cyclic delay) to an Nth instance of the uplink signal 215 for the antenna 240-c (e.g., cyclic delay * N). In this way, each instance of the uplink signal 215 is delayed from a previous instance of the uplink signal 215 by the cyclic delay value.

In such examples, sᵢ(k) may be calculated according to Equation 1.

$${s}_{i} ( k ) = \frac{1}{\sqrt{{N}_{T}}} * \tilde{s} ( k - {δ}_{i} ) , i = 0 , … , {N}_{T} - 1 \qquad ( 1 )$$

In some examples, CDD schemes may be large delay CDD schemes (LD-CDD schemes) or small delay CDD schemes (SD-CDD schemes). In some cases, the cyclic delay value (e.g., δ) may be shorter than the difference between a cyclic prefix length and a threshold channel delay (e.g., a small delay) or larger than the difference between a cyclic prefix length and a threshold channel delay (e.g., a large delay). In some cases, LD-CDD values may be predefined, which may allow the UE 115-a to implement the LD-CDD values in a non-transparent manner. For example, LD-CDD values may be determined (e.g., by the network entity 105-a, by the UE 115-a) based on a mapping, such as in Table 1:

TABLE 1

| | 2Tx | 4Tx |
|---|---|---|
| R = 1 | No cycling | ${C}_{0}^{( 1 )} , {C}_{1}^{( 1 )} , {C}_{2}^{( 1 )} , {C}_{3}^{( 1 )}$ |
| R = 2 | $\frac{1}{\sqrt{2}} [ \begin{matrix}1 & 1 \\ {e}^{- j 2 π i / 2} & - {e}^{- j 2 π i / 2}\end{matrix} ]$ | $\frac{1}{\sqrt{2}} {C}_{i}^{( 2 )} [ \begin{matrix}1 & 1 \\ {e}^{- j 2 π i / 2} & - {e}^{- j 2 π i / 2}\end{matrix} ]$ |
| R = 3 | N/A | $\frac{1}{\sqrt{3}} {C}_{i mod 4}^{( 3 )} [ \begin{matrix}1 & 1 & 1 \\ {e}^{- j 2 π i / 3} & {e}^{- j 2 π i / 3} {e}^{- j 2 π i / 3} & {e}^{- j 4 π i / 3} {e}^{- j 2 π i / 3} \\ {e}^{- j 4 π i / 3} & {e}^{- j 4 π i / 3} {e}^{- j 4 π i / 3} & {e}^{- j 8 π i / 3} {e}^{- j 4 π i / 3}\end{matrix} ]$ |
| R = 4 | N/A | $\frac{1}{2} {C}_{i mod 4}^{( 4 )} [ \begin{matrix}1 & 1 & 1 & 1 \\ {e}^{- j 2 π i / 4} & - {je}^{- j 2 π i / 4} & - {e}^{- j 2 π i / 4} & {je}^{- j 2 π i / 4} \\ {e}^{- j 4 π i / 4} & - {e}^{- j 4 π i / 4} & - {e}^{- j 4 π i / 4} & - {e}^{- j 4 π i / 4} \\ {e}^{- j 6 π i / 4} & {je}^{- j 6 π i / 4} & - {e}^{- j 6 π i / 4} & - {je}^{- j 6 π i / 4}\end{matrix} ]$ |

Table 1 may provide an example of a mapping between a quantity of transmitters (Tx) (e.g., antennas 240, antenna panels, antenna groups) and R may indicate a quantity of layers.

$${C}_{0}^{( 1 )} , {C}_{1}^{( 1 )} , {C}_{2}^{( 1 )} , {C}_{3}^{( 1 )}$$

may denote rank-K precoding matrices that may correspond to different indices (e.g., indices 12, 13, 14, 15, respectively). j may be related to a phase shift. However, LD-CDD may not be supported for multi-port DMRS in some wireless communications systems (e.g., NR communication systems). Instead, the UE 115-a and the network entity 105-a may support SD-CDD in a transparent manner for the wireless communications systems (e.g., NR communications systems.

In such cases, as part of SD-CDD, the UE 115-a may calculate or determine the instances of the uplink signal 215 sᵢ(k) by first transitioning data symbols (e.g., S(l), l=0, . . . , N_{FFT}-1) in the frequency domain to the time domain (e.g., via an inverse fast Fourier transform (IFFT)), resulting in s (k), and applying a delay in the time domain to the data symbols. The time delay of the signal in the time domain may be reflected in a phase shift of the data symbols in the frequency domain. That is, the cyclic delay value (e.g., SD-CDD) may be a time delay in the time domain with an associated phase shift in the frequency domain. Applying the time delay may be according to an equation, such as Equation 1 or Equation 2.

$${s}_{i} ( k ) = \frac{1}{\sqrt{{N}_{T}}} * \tilde{s} ( k - {δ}_{i}^{cyc} mod {N}_{FFT} ) , i = 0 , … , {N}_{T} - 1 , \\ k = - {N}_{G} , … , {N}_{FFT} - 1 \qquad ( 2 )$$

N_{FFT} may be a quantity of data symbols of the uplink signal 215. The range of k may be determined in accordance with the IFFT.

Based on applying the cyclic delay values and cyclic prefixes to each instance of the signal, the UE 115-a may transmit the instances of the uplink signal 215 via respective antennas 240 and according to the cyclic delay value. The network entity 105-a may receive the instances of the uplink signal 215 and may perform cyclic-prefix removal and perform a fast Fourier transform (FFT) to the instance of the uplink signal 215. The network entity 105-a may perform channel estimation based on the received instances of the uplink signal 215. Equation 3 may be an example of the uplink signal observed by the network entity 105-a (e.g., the receiver):

$$R ( l ) = [ \frac{1}{\sqrt{{N}_{T}}} {\sum }_{i = 0}^{{N}_{T} - 1} {e}^{- j \frac{2 π}{{N}_{FFT}} {δ}_{i}^{cyc} l} {H}_{i} ( l ) ] S ( l ) + N ( l ) \qquad ( 3 )$$

R (l) may be the observed or received uplink signal 215. S (l) may be the original signal (e.g., the data symbols).

$$[ {\sum }_{i = 0}^{{N}_{T} - 1} {e}^{- j \frac{2 π}{{N}_{FFT}} {δ}_{i}^{cyc} l} {H}_{i} ( l ) ]$$

may be an effective channel H (l), where Hᵢ(l) may be a channel estimation for each instance of the uplink signal 215 (e.g., i). The effective channel H (l) may depend on the applied cyclic delay value, δ. N (l) may be the noise at the 1-th frequency tones.

In some implementations, the UE 115-a may transmit the instances of the uplink signal 215 with a threshold delay or less than a threshold delay. For example, the threshold delay after applying a CDD scheme may be

$$[ ( {δ}_{max}^{cyc} + {N}_{max} ) mod {N}_{FFT} ] \times {τ}_{s} , where {δ}_{max}^{cyc} may be {max}_{i} {δ}_{i}^{cyc} ,$$

Nₘₐₓ may be the threshold channel delay in terms of samples, and τₛ may be the sampling rate.

In some implementations, such as transparent CDD schemes (e.g., SD-CDD) where the network entity 105-a may not be provided with the delay value, the network entity 105-a may determine, estimate, or calculate a threshold delay (e.g., a threshold SD-CDD value) that the UE 115-a may implement in order to perform channel estimation, such as in Equation 3.

In some cases, the network entity 105-a may assume that cyclic delay values (e.g., SD-CDD values) may satisfy a threshold. For example,

$${δ}_{max}^{cyc} < cyclic prefix length - {N}_{max}$$

may be satisfied, where Nₘₐₓ may represent a threshold channel delay in terms of samples. In some cases, the network entity 105-a may calculate the cyclic prefix length based on a quantity of samples (e.g., τₛ). For example, in a 30 KHz subcarrier spacing system, a cyclic prefix length (e.g., duration) may be equal to 288 samples, and the network entity 105-a may calculate a cyclic prefix length of 2.34 us based on the 288 samples. In some cases, the network entity 105-a may calculate or estimate the delay spread or the threshold delay associated with the PDP by combining a channel delay and a cyclic delay, which may be transparently measured at the network entity 105-a, or another receiving device. For example, the network entity 105-a may calculate, measure, or determine that a root mean square (RMS) delay in the above example of 288 samples is 300 ns. The network entity 105-a may perform channel estimation based on the calculated delay spread or threshold delay, which may be associated with a measured PDP, and then demodulation may be carried out. In the case of the transparent CDD scheme (e.g., SD-CDD), the network entity 105-a may apply a suboptimal channel estimation. For example, the network entity 105-a may apply a channel estimation (e.g., minimum mean-square error (MMSE) channel estimation) based on a frequency domain correlation assuming a uniform PDP with a threshold delay of 2*300 ns (e.g., in the above example of 288 samples), regardless of whether the UE 115-a is employing an SD-CDD scheme (e.g., if the instances of the uplink signal 215 are delayed at all), or if the calculated delay value (e.g., SD-CDD value) is accurate. In some cases, the network entity 105-a may function as if the UE 115-a applied no CDD scheme to the instances of the uplink signal 215. This may result in channel estimation being performed at the network entity 105-a (or the receiving device) without accurate delay spread estimation (e.g., PDP estimation), which may rely on the delay value (e.g., CDD parameter).

For more accurate delay information, it may be beneficial for a reference signal (e.g., tracking reference signal) to apply an SD-CDD value such that the network entity 105-a may use the reference signal to perform accurate channel estimation including the SD-CDD value. However, if the reference signal does not apply the SD-CDD value, an applied CDD value may be restricted to a “very small” CDD value (e.g., smaller than an SD-CDD value, or an SD-CDD value below a threshold) to avoid performance degradation due to CDD value mismatch between the UE 115-a and the network entity 105-a, which may limit potential transmission diversity gain.

In some implementations, the UE 115-a may determine an SD-CDD value (e.g., a cyclic delay value, delay value) based on an MCS, a channel delay spread, a resource allocation (e.g., allocated bandwidth for transmission of the instances of the uplink signal 215), or any combination thereof. The UE 115-a may apply the SD-CDD value to the instances of the uplink signal 215 for potential diversity gain, as previously described. The UE 115-a may have multiple antennas 240 for a single port transmission using the SD-CDD scheme. In some cases, the network entity 105-a may receive the instances of the uplink signal 215 and may determine that the UE 115-a uses a single port, although the UE 115-a may use multiple antennas to send the instances of the uplink signal 215. Thus, the network entity 105-a may not have any indication that a cyclic delay value was applied to the instances of the uplink signal 215 at the antennas 240, particularly when the network entity 105-a may schedule instances of the uplink signal 215 by a DCI (e.g., DCI 0_0). This may result in a misalignment at the network entity 105-a between an actual PDP (e.g., without SD-CDD) and an effective PDP (e.g., with SD-CDD), which may occur for PUSCH or physical uplink control channel (PUCCH) transmissions. The network entity 105-a may calculate a PDP for DMRS channel estimation for MMSE detection, and the misalignment may degrade channel estimation performance.

Thus, to increase potential diversity gain (e.g., to apply cyclic delay values), the wireless communications system 200 may support cyclic delay value reporting (e.g., SD-CDD value reporting). The UE 115-a may receive control signaling 205 from the network entity 105-a that may allocate uplink resources for the UE 115-a. The UE 115-a may use associated MCS, bandwidth parts, channel delay spread, or any combination thereof, to determine cyclic delay values (e.g., SD-CDD values) for the uplink resources. The UE 115-a may report the cyclic delay values in the SD-CDD value report 210 to the network entity 105-a. The network entity 105-a may utilize the report of the cyclic delay values to perform more accurate channel estimation when receiving instances of the uplink signal 215.

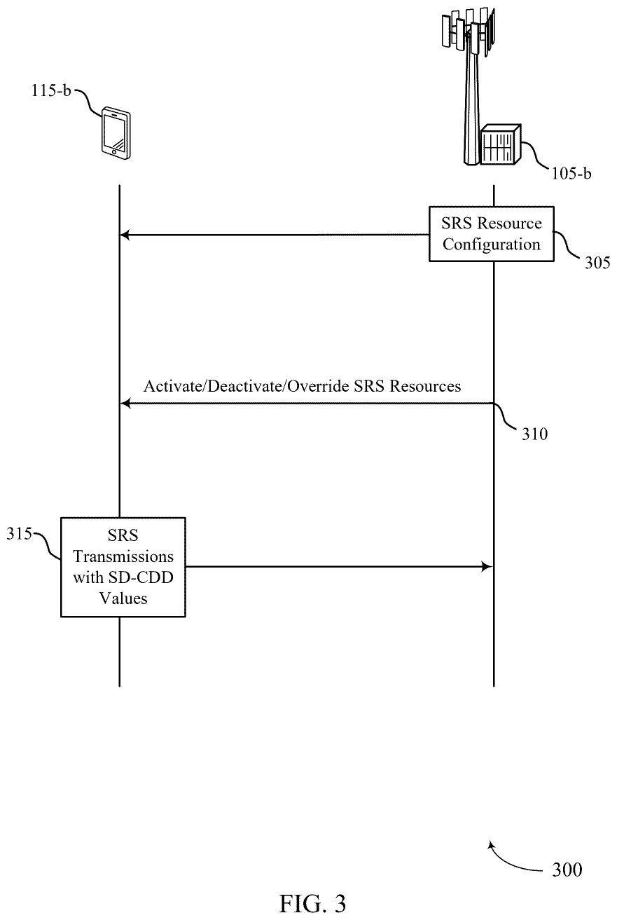

FIG. 3 shows an example of a process flow 300 that supports cyclic delay value reporting in accordance with one or more aspects of the present disclosure. The process flow 300 may implement, or be implemented to realize, aspects of the wireless communications system 100 and the wireless communications system 200. For example, the process flow 300 illustrates communication between a UE 115-b and a network entity 105-b, which may be examples of corresponding devices described herein, including with reference to FIGS. 1 and 2. The techniques described in the context of the process flow 300 may enable the UE 115-b to report cyclic delay values (e.g., SD-CDD values) by transmitting SRS in one or more allocated SRS resources.

At 305, the UE 115-b may receive, from the network entity 105-b, control signaling allocating uplink resources, such as one or more SRS resources. That is, the network entity 105-b may transmit an SRS configuration to the UE 115-b, where the network entity 105-b may allocate multiple SRS resources such that a different cyclic delay value (e.g., SD-CDD value) may be applied in the different SRS resources. For example, each SRS resource may be associated with an allocated bandwidth (e.g., bandwidth part) for uplink transmission (e.g., different SRS resources may be associated with different resource allocation). Additionally, or alternatively, different SRS resources may be associated with a different MCS (e.g., each SRS resource has an associated MCS). In some cases, different SRS resources may be associated with both an allocated bandwidth and an MCS. In some cases, the control signaling at 405 may be an example of the control signaling 205 described with reference to FIG. 2.

In some implementations, at 310, the UE 115-b may receive control signaling that activates, deactivates, overrides, or a combination of each, at least one SRS resource of the one or more SRS resources, as described at 305. In some cases, the control signaling indicating the activation, deactivation, or override may be the same as the control signaling configuring the SRS resources, as described at 305. In other cases, the control signaling indicating the activation, deactivation, or override may be different from the control signaling configuring the SRS resources, as described at 305.

That is, at 310, the network entity 105-b may activate, deactivate, or override the at least one SRS resource on which the UE 115-b may transmit the SRS. For example, the network entity 105-b may allocate a quantity of SRS resources, such as three SRS resources, as described at 310. In some examples, the network entity 105-b may activate at least one of the allocated SRS resources. For example, the network entity 105-b may activate two SRS resources of the three allocated SRS resources, indicating for the UE 115-b to transmit SRS via the two activated SRS resources. In some examples, the network entity 105-b may deactivate at least one of the allocated SRS resources. For example, the network entity 105-b may deactivate two SRS resources of the three allocated SRS resources, indicating for the UE 115-b not to transmit SRSs via the two deactivated SRS resources. In some examples, the network entity 105-b may override at least one of the allocated SRS resources. For example, the network entity 105-b may override, or update, two SRS resources of the three allocated SRS resources.

At 315, the UE 115-b may transmit an indication of one or more cyclic delay values in accordance with receiving the control signaling, as described at 305. For example, to indicate each of the cyclic delay values, the UE 115-b may transmit a respective SRS via the allocated SRS resources, where each of the one or more SRS is transmitted according to a respective cyclic delay value of the one or more cyclic delay values. That is, at 315, the UE 115-b may transmit SRS transmissions with the one or more cyclic delay values (e.g., SD-CDD values). In some implementations, each cyclic delay value of the one or more cyclic delay values may be associated with the respective MCS (e.g., MCS value), the respective bandwidth, or both, as described at 305.

As an illustrative example, the UE 115-b may calculate a first cyclic delay value for a first SRS resource based on the channel delay spread, a MCS associated with the first SRS resource, a bandwidth part associated with the first SRS resource, or a combination thereof. Similarly, the UE 115-b may calculate a second cyclic delay value for a second SRS resource based on the channel delay spread, a MCS associated with the second SRS resource, a bandwidth part associated with the second SRS resource, or both. Accordingly, the UE 115-b may, at 310, transmit one or more instances of a first SRS via the first SRS resource according to the first cyclic delay value, in accordance with the techniques described herein with reference to FIG. 2. Similarly, the UE 115-b may transmit one or more instances of a second SRS via the second SRS resource according to the second cyclic delay value, in accordance with the techniques described herein with reference to FIG. 2.

In some cases, the network entity 105-b may not indicate an MCS for an SRS resource and the UE may use a calculated channel quality indicator as a default value to determine the cyclic delay value. That is, at least one cycle delay value of the one or more cyclic delay values may be associated with respective channel quality information for at least one SRS resource of the one or more SRS resources in accordance with an absence of an indication of an MCS for the at least one SRS resource.

In some examples, the UE 115-b may transmit an SRS with a cyclic delay value associated with a different bandwidth than the transmitted SRS to request an uplink grant or an activation of a different SRS resource. For example, the network entity 105-b may allocate bandwidths of 4 resource blocks (RBs) (e.g., frequency spanning four RBs), 20 RB, 273 RB, or others. In some examples, the UE 115-b may transmit the SRS in 273 RB with a cyclic delay value, where the cyclic delay value may be associated with or calculated based on 4 RB. The network entity 105-b may perform a PDP estimation based on the SRS with the cyclic delay value, and may schedule (e.g., grant) 4 RB for a follow-up uplink transmission (e.g., one or more uplink signals or PUSCH transmissions). In some cases, the one or more SRS transmitted with one or more cyclic delay values at 315 may be an example of the SD-CDD value report 210 described with reference to FIG. 2.

In some implementations, the network entity 105-b may receive one or more SRS via the one or more SRS resources, where each of the one or more SRS is transmitted according to a respective cyclic delay value of the one or more cyclic delay values, as described at 315. The network entity 105-a may measure an effective channel H (l), as described with respect to Equation 2, based on receiving the one or more SRS. Because the network entity 105-b may measure an effective channel H (l), the network entity 105-b may implicitly identify the cyclic delay values or may calculate a cyclic specific delay value based on the calculated effective channel H (l) based on Equation 2.

In some examples, by receiving the SRS via the SRS resource associated with the allocated MCS, the allocated bandwidth, or both, the network entity 105-b may be able to implicitly determine the SD-CDD value indicated by the UE 115-b (e.g., by calculating the SD-CDD value applied to the SRS). In some examples, the bandwidth on which an SRS transmitted may indicate the value of a cyclic delay value to the network entity 105-b. In some examples, the cyclic delay value may be associated with an MCS and a network entity 105-b may determine a PDP based on the MCS.

In some implementations, the UE 115-b may transmit one or more uplink signals in accordance with the one or more cyclic delay values, as described at 315, in accordance with the control signaling, as described at 305, or both. The one or more uplink signals may include a PUSCH or a PUCCH. For example, the network entity 105-b may allocate resources for the UE 115-b to use based on receiving the SRS transmissions, as described at 315. The UE 115-b may transmit the one or more uplink signals via the allocated resources and according to the one or more cyclic delay values, as described at 315. In some cases, the UE 115-b may transmit the one or more uplink resources at any time after transmitting the SRS transmission, as described at 315. That is, the UE 115-b may not wait for a duration to pass between the SRS transmissions and the one or more uplink signals.

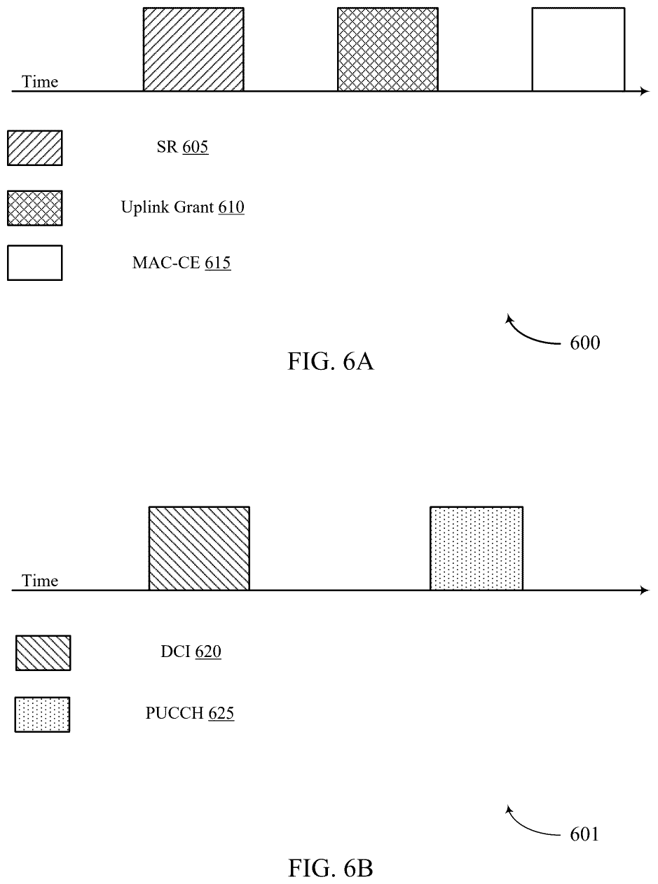

In some implementations, the UE 115-b may request resources to transmit an indication of one or more updated cyclic delay values or the network entity 105-b may request that the UE 115-b update the one or more cyclic delay values that the UE 115-b may report at 315, as described further with reference to FIGS. 6A and 6B. In some cases, the UE 115-b may report or indicate one or more updated cyclic delay values by transmitting one or more second SRS. In some cases, the network entity 105-b may request an updated SD-CDD value report by transmitting second control signaling allocating one or more second SRS resources.

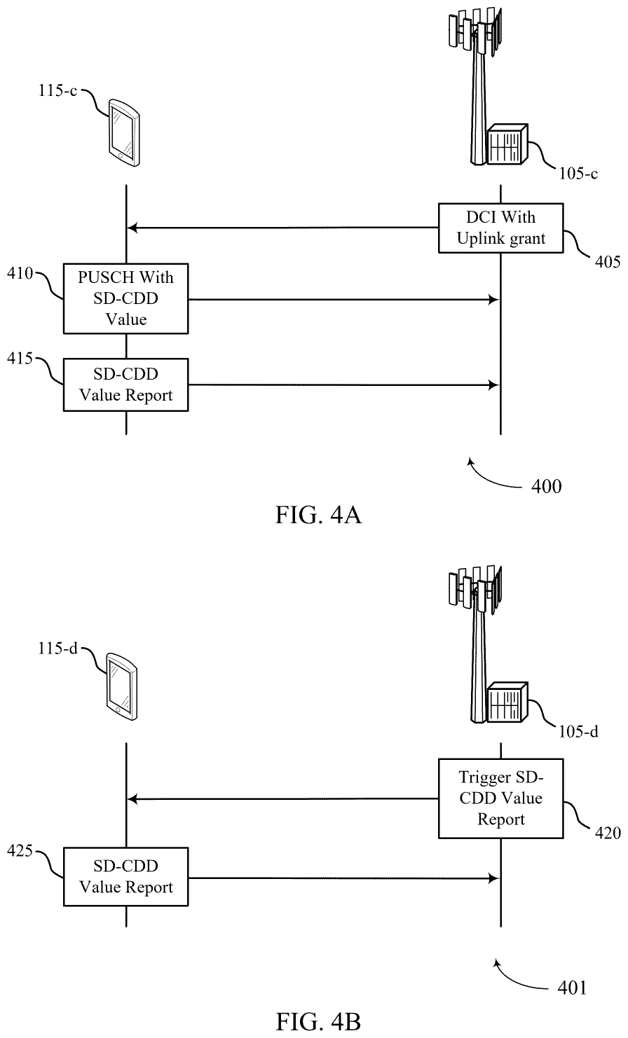

FIGS. 4A and 4B show examples of a process flow 400 and a process flow 401, respectively, that support cyclic delay value reporting in accordance with one or more aspects of the present disclosure. The process flow 400 and the process flow 401 may implement, or be implemented to realize, aspects of the wireless communications system 100 and the wireless communications system 200. For example, the process flow 400 illustrates communication between a UE 115-c and a network entity 105-c and the process flow 401 illustrates communication between a UE 115-d and a network entity 105-d, which may be examples of corresponding devices described herein, including with reference to FIGS. 1-3. The techniques described in the context of the process flow 400 and the process flow 401 may enable the UEs 115 to report cyclic delay values (e.g., SD-CDD values) via explicit signaling.

With respect to process flow 400, at 405, the UE 115-c may receive, from the network entity 105-c, control signaling allocating uplink resources for a PUSCH transmission. In some implementations, the control signaling may be DCI received via a PUCCH, where the DCI includes an uplink grant for the PUSCH. In such examples, the network entity 105-c may request, via the control signaling, for the UE 115-c to transmit an indication of a cyclic delay value associated with the PUSCH transmission. For example, the network entity 105-c may indicate, via the control signaling, a MCS for the PUSCH transmission, a bandwidth part for the PUSCH transmission, or both. Based on receiving the control signaling with the uplink grant at 405, the UE 115-c may determine (e.g., calculate) the cyclic delay value associated with the PUSCH transmission based on the allocated MCS, on the allocated bandwidth part, on the channel delay spread, or a combination thereof.

At 410, the UE 115-c may transmit the PUSCH according to the cyclic delay value (e.g., SD-CDD value) via the allocated uplink resources. For example, the UE 115-c may transmit one or more instances of the PUSCH transmission according to the cyclic delay value, where each instance of the PUSCH transmission may be transmitted via a respective antenna element, as described herein with reference to FIG. 2.

At 415, the UE 115-c may transmit, to the network entity 105-c, an indication of the cyclic delay value used in the transmission of the PUSCH via an SD-CDD value report. In such examples, the UE 115-c may transmit the SD-CDD value report via a PUCCH (e.g., uplink control information of a PUCCH) or via a medium access control-control element (MAC-CE).

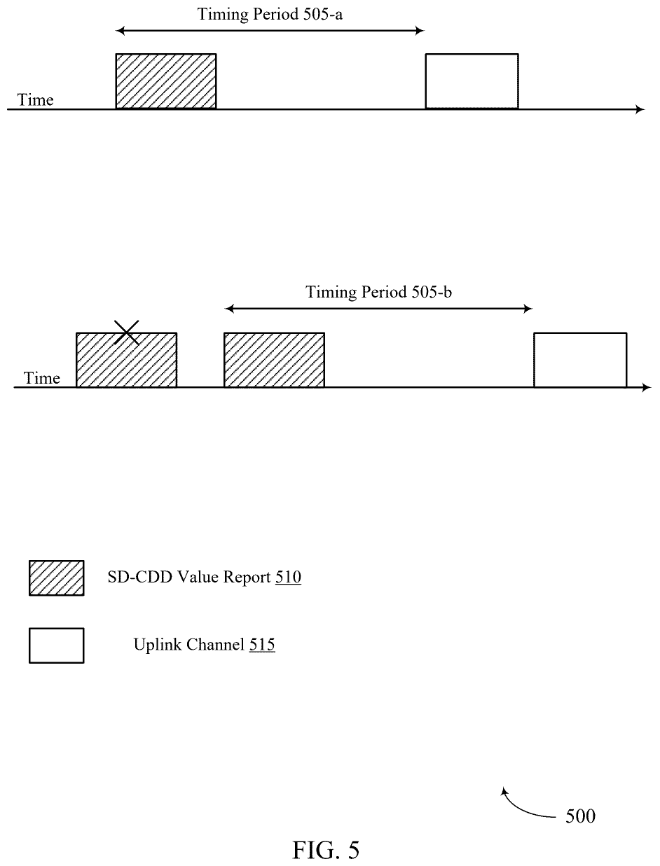

In some implementations, the UE 115-c may transmit the SD-CDD value report prior to transmitting the PUSCH, such that the network entity 105-c may identify the cyclic delay value, perform channel measurements, and successfully receive and decode the PUSCH transmission. In such examples, transmitting the PUSCH, as described at 410, and transmitting the SD-CDD value report may be associated with a timing period, as described further with respect to FIG. 5. For example, the UE 115-c may transmit the PUSCH (e.g., one or more uplink signals) after a first duration from the transmission of the cyclic delay value.

Alternatively, in some examples, the UE 115-c may transmit the SD-CDD value report after transmitting the PUSCH, where the network entity 105-c may perform channel measurements using the indicated cyclic delay value and successfully receive and decode the PUSCH transmission using the channel measurements. In some other examples, the UE 115-c may transmit the SD-CDD value report at a same time as the PUSCH transmission.

In some implementations, the UE 115-c may request resources to transmit an updated SD-CDD value report or the network entity 105-c may request that the UE 115-c update the one or more cyclic delay values that the UE 115-c may report at 415, as described further with reference to FIGS. 6A and 6B. In some cases, the requests to update the one or more cyclic delay values may be in accordance with transmitting the indication of the one or more cyclic delay values at 415. In this way, the UE 115-c may indicate the cyclic delay value associated with the uplink transmission to the network entity 105-c, such that the network entity 105-c may accurately perform channel measurements and successfully receive and decode the uplink transmission.

With respect to process flow 401, a network entity 105-d may request a UE 115-d to report one or more cyclic delay values (e.g., multiple SD-CDD values), where each of the one or more cyclic delay values may be associated with a different bandwidth and a different MCS. In such examples, the UE 115-d may receive control signaling (e.g., second control signaling, DCI, MAC-CE) requesting a report of the one or more cyclic delay values, where the network entity 105-d may indicate, via the control signaling, one or more MCS values, one or more bandwidth parts, or both. Accordingly, based on receiving the control signaling triggering the SD-CDD value report, the UE 115-d may determine the one or more cyclic delay values based on respective MCS values, respective bandwidth parts, or both.

At 425, based on determining the cyclic delay values, the UE 115-d may transmit the SD-CDD value report to the network entity 105-d. That is, the UE 115-d may transmit an indication of the one or more requested cyclic delay values in accordance with receiving the request at 420. In some cases, the UE 115-a may transmit the SD-CDD value report via a PUCCH, an aperiodic PUCCH, or a MAC-CE.

FIG. 5 shows an example of a timing diagram 500 that supports cyclic delay value reporting in accordance with one or more aspects of the present disclosure. The timing diagram 500 may implement, or be implemented to realize, aspects of the wireless communications system 100 and the wireless communications system 200, as well as the process flow 300, the process flow 400, and the process flow 401. The techniques described in the context of the timing diagram 500 may define a timing period 505 associated with cyclic delay value reporting.

In some implementations, a UE 115 may transmit an SD-CDD value report 510 and an uplink channel 515 (e.g., PUCCH, PUSCH) with a cyclic delay value indicated in the SD-CDD value report 510 based on a timing period 505 (e.g., T). For example, the UE 115 may transmit the uplink channel 515 (e.g., one or more uplink signals), in accordance with one or more cyclic delay values (e.g., SD-CDD values), after a timing period 505-a (e.g., first duration) from transmitting the indication of the one or more cyclic delay values in the SD-CDD value report 510. In some cases, as described with reference to FIGS. 4A and 4B, the UE 115 may transmit the SD-CDD value report 510 via a PUCCH or a MAC-CE. That is, the UE 115 may explicitly report the one or more cyclic delay values through transmission of the SD-CDD value report 510 via PUCCH or MAC-CE. The UE 115 may not apply the one or more cyclic delay values to the uplink channel 515 (e.g., the one or more uplink signals) until after a timing period 505-a from the transmission of the SD-CDD value report 510.

In some cases, the network entity 105 may transmit an uplink grant for retransmission of the SD-CDD value report 510, and the timing period 505 may restart or may be recounted. For example, the UE 115 may attempt to transmit a first SD-CDD value report 510, where the network entity 105 may not receive or decode the first SD-CDD value report 510. Accordingly, the network entity 105 may transmit an uplink grant for the retransmission of the SD-CDD value report 510. Based on the uplink grant, the UE may transmit the SD-CDD value report 510 and not transmit the uplink channel 515 until after a timing period 505-b, where the timing period 505-b may start at the retransmission of the updated or the second SD-CDD value report 510. The timing period 505 may be based on a standardized value, a processing capability at the network entity 105, a processing capability at the UE 115, or any combination thereof.

In some cases, as described with respect to FIG. 3, a SD-CDD value report 510 may be transmitted through one or more SRSs transmitted by the UE 115 with a cyclic delay value (e.g., SD-CDD value). That is, the UE 115 may implicitly report the one or more cyclic delay values via the SRS transmissions. In some examples, the UE may apply a cyclic delay value of the one or more cyclic delay values to the uplink channel 515 in response to (e.g., after) transmitting the SRS. That is, the UE 115 may not wait for the timing period 505 to pass before transmitting the uplink channel 515 when the UE 115 may report the one or more cyclic delay values via SRS transmission. Alternatively, in some examples, the UE 115 may wait a duration of time (e.g., the timing period 505 after the transmission of the SRSs to transmit the uplink channel 515.

FIGS. 6A and 6B show examples of a timing diagram 600 and a timing diagram 601, respectively, that support cyclic delay value reporting in accordance with one or more aspects of the present disclosure. The timing diagram 600 and the timing diagram 601 may implement, or be implemented to realize, aspects of the wireless communications system 100 and the wireless communications system 200, as well as the process flow 300, the process flow 400, the process flow 401, and the timing diagram 500. The techniques described in the context of the timing diagram 600 and timing diagram 601 may provide signaling techniques for a UE 115 to update a report or indication of one or more cyclic delay values.

In some implementations, the UE 115 may receive control signaling allocating one or more uplink resources. The UE 115 may transmit an indication (e.g., SD_CDD value report) of one or more cyclic delay values (e.g., SD-CDD values) in accordance with receiving the control signaling. The UE 115 may transmit one or more uplink signals (e.g., PUSCH or PUCCH) in accordance with the one or more cyclic delay values, in accordance with the control signaling, or both. In some implementations, the one or more cyclic delay value report may be updated at the request of the UE 115, as described with respect to timing diagram 600, or the network entity 105, as described with reference to timing diagram 601.

With respect to timing diagram 600, the UE 115 may initiate an update to the report or indication of the one or more cyclic delay values. The UE 115 may transmit a scheduling request (SR) 605 requesting to update the one or more cyclic delay values in accordance with transmitting the indication of the one or more cyclic delay values. The UE 115 may receive an uplink grant 610 in accordance with transmitting the SR 605. The network entity 105 may allocated the uplink grant 610 for the UE 115 to use for the transmission of the updated one or more cyclic delay values (e.g., the updated SD-CDD value report). That is, the UE 115 may receive, from the network entity 105, second control signaling, the second control signaling allocating one or more second uplink resources. The UE 115 may transmit an updated SD-CDD value report in a MAC-CE 615 (or a PUCCH or an aperiodic PUCCH). That is, the UE 115 may transmit a second indication of the one or more updated cyclic delay values in accordance with the one or more uplink resources.

With respect to timing diagram 601, a network entity 105 may request the UE 115 to update the report or indication of the one or more cyclic delay values (e.g., the SD-CDD value report) by transmitting a DCI 620 to the UE 115, where the DCI 620 may indicate one or more MCSs, one or more bandwidth parts, or both for which the UE 115 is to report the cyclic delay values. Based on receiving the DCI 620, the UE 115 may calculate the one or more cyclic delay values and transmit the one or more updated cyclic delay values via an aperiodic PUCCH 625 (or a MAC-CE or a PUCCH).

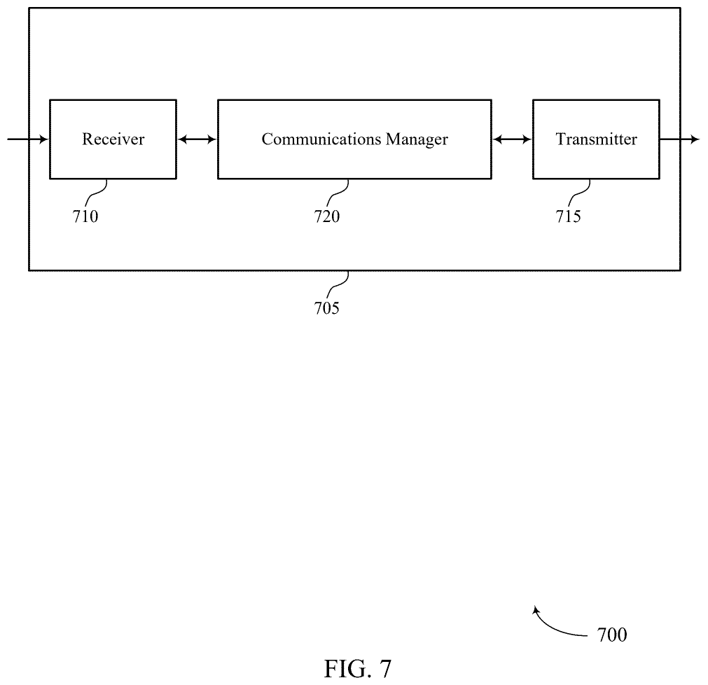

FIG. 7 shows a block diagram 700 of a device 705 that supports cyclic delay value reporting in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to cyclic delay value reporting). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to cyclic delay value reporting). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of cyclic delay value reporting as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. For example, the communications manager 720 is capable of, configured to, or operable to support a means for receiving control signaling allocating one or more uplink resources. The communications manager 720 is capable of, configured to, or operable to support a means for transmitting an indication of one or more cyclic delay values in accordance with receiving the control signaling, where each cyclic delay value of the one or more cyclic delay values corresponds to a delay between one or more instances of a signal, each instance of the signal transmitted via a respective antenna at the UE. The communications manager 720 is capable of, configured to, or operable to support a means for transmitting one or more uplink signals in accordance with the one or more cyclic delay values, in accordance with the control signaling, or both.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for improved communication reliability, reduced latency, and more efficient utilization of communication resources.

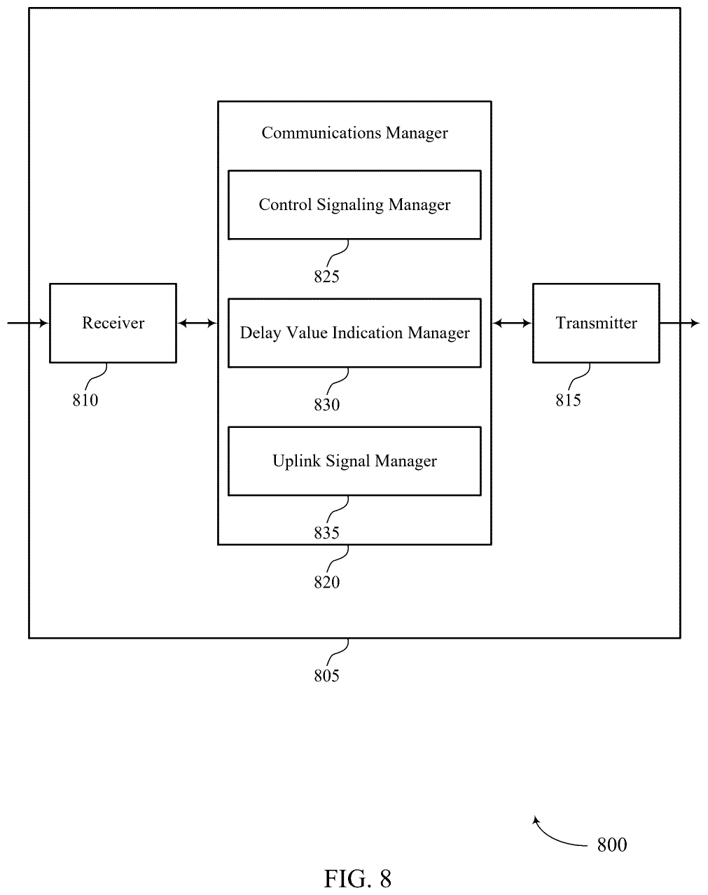

FIG. 8 shows a block diagram 800 of a device 805 that supports cyclic delay value reporting in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to cyclic delay value reporting). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to cyclic delay value reporting). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of cyclic delay value reporting as described herein. For example, the communications manager 820 may include a control signaling manager 825, a delay value indication manager 830, an uplink signal manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. The control signaling manager 825 is capable of, configured to, or operable to support a means for receiving control signaling allocating one or more uplink resources. The delay value indication manager 830 is capable of, configured to, or operable to support a means for transmitting an indication of one or more cyclic delay values in accordance with receiving the control signaling, where each cyclic delay value of the one or more cyclic delay values corresponds to a delay between one or more instances of a signal, each instance of the signal transmitted via a respective antenna at the UE. The uplink signal manager 835 is capable of, configured to, or operable to support a means for transmitting one or more uplink signals in accordance with the one or more cyclic delay values, in accordance with the control signaling, or both.

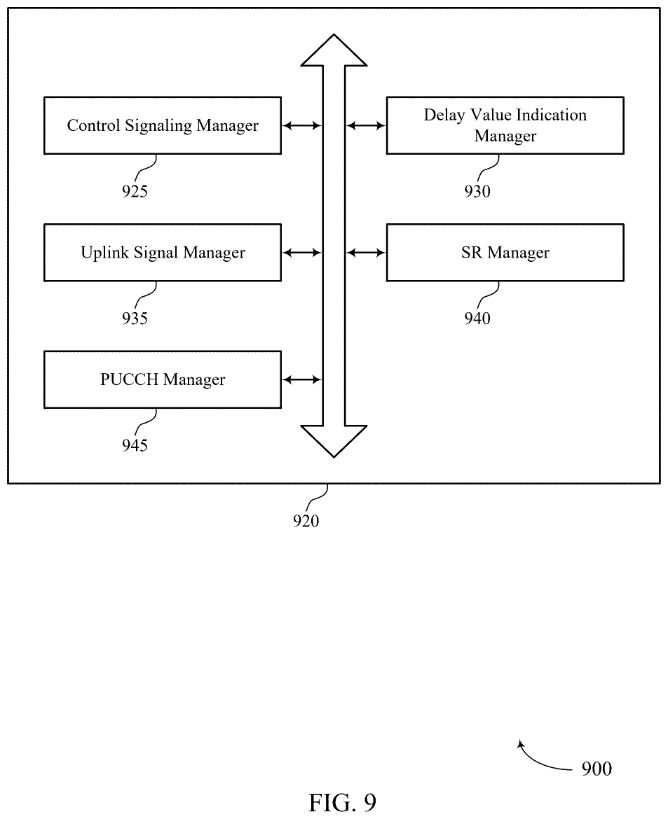

FIG. 9 shows a block diagram 900 of a communications manager 920 that supports cyclic delay value reporting in accordance with one or more aspects of the present disclosure. The communications manager 920 may be an example of aspects of a communications manager 720, a communications manager 820, or both, as described herein. The communications manager 920, or various components thereof, may be an example of means for performing various aspects of cyclic delay value reporting as described herein. For example, the communications manager 920 may include a control signaling manager 925, a delay value indication manager 930, an uplink signal manager 935, a SR manager 940, a PUCCH manager 945, or any combination thereof. Each of these components, or components or subcomponents thereof (e.g., one or more processors, one or more memories), may communicate, directly or indirectly, with one another (e.g., via one or more buses).

The communications manager 920 may support wireless communication in accordance with examples as disclosed herein. The control signaling manager 925 is capable of, configured to, or operable to support a means for receiving control signaling allocating one or more uplink resources. The delay value indication manager 930 is capable of, configured to, or operable to support a means for transmitting an indication of one or more cyclic delay values in accordance with receiving the control signaling, where each cyclic delay value of the one or more cyclic delay values corresponds to a delay between one or more instances of a signal, each instance of the signal transmitted via a respective antenna at the UE. The uplink signal manager 935 is capable of, configured to, or operable to support a means for transmitting one or more uplink signals in accordance with the one or more cyclic delay values, in accordance with the control signaling, or both.

In some examples, the control signaling allocates one or more SRS resources. In some examples, each of the one or more SRS resources is associated with a respective MCS, a respective bandwidth, or both.

In some examples, to support transmitting the indication, the delay value indication manager 930 is capable of, configured to, or operable to support a means for transmitting one or more SRSs via the one or more SRS resources, where each of the one or more SRSs is transmitted according to a respective cyclic delay value of the one or more cyclic delay values.

In some examples, the control signaling manager 925 is capable of, configured to, or operable to support a means for receiving second control signaling activating or deactivating at least one SRS resource of the one or more SRS resources, where transmitting the indication of the one or more cyclic delay values is in accordance with the activation or the deactivation.

In some examples, the control signaling manager 925 is capable of, configured to, or operable to support a means for receiving second control signaling overriding at least one SRS resource of the one or more SRS resources, where transmitting the indication of the one or more cyclic delay values is in accordance with overriding the at least one SRS resource.

In some examples, each cyclic delay value of the one or more cyclic delay values is associated with the respective MCS, the respective bandwidth, or both.

In some examples, at least one cycle delay value of the one or more cyclic delay values is associated with respective channel quality information for at least one SRS resource of the one or more SRS resources in accordance with an absence of an indication of a MCS for the at least one SRS resource.

In some examples, to support receiving the control signaling, the control signaling manager 925 is capable of, configured to, or operable to support a means for receiving DCI allocating the one or more uplink resources and requesting transmission of the one or more cyclic delay values, where transmitting the indication of the one or more cyclic delay values is in accordance with receiving the DCI.

In some examples, the DCI further indicates one or more MCSs, one or more bandwidths, or both associated with the one or more uplink resources. In some examples, each cyclic delay value of the one or more cyclic delay values is associated with a respective MCS, a respective bandwidth, or both.

In some examples, to support transmitting the indication, the delay value indication manager 930 is capable of, configured to, or operable to support a means for transmitting a report indicating the one or more cyclic delay values via a PUCCH or via a media access control-control element.

In some examples, the SR manager 940 is capable of, configured to, or operable to support a means for transmitting an SR requesting to update the one or more cyclic delay values in accordance with transmitting the indication of the one or more cyclic delay values. In some examples, the control signaling manager 925 is capable of, configured to, or operable to support a means for receiving second control signaling, the second control signaling allocating one or more second uplink resources. In some examples, the delay value indication manager 930 is capable of, configured to, or operable to support a means for transmitting a second indication of the one or more updated cyclic delay values in accordance with the one or more second uplink resources.

In some examples, the control signaling manager 925 is capable of, configured to, or operable to support a means for receiving, in accordance with transmitting the indication, second control signaling requesting an update to the one or more cyclic delay values. In some examples, the PUCCH manager 945 is capable of, configured to, or operable to support a means for transmitting, via an aperiodic PUCCH, the one or more updated cyclic delay values.

In some examples, transmitting the one or more uplink signals is after a first duration from transmitting the indication of the one or more cyclic delay values.

In some examples, the one or more uplink signals include a PUCCH or a PUSCH.

In some examples, the one or more cyclic delay values include one or more small delay cyclic delay diversity values. In some examples, each small delay cyclic diversity value of the one or more small delay cyclic delay diversity values satisfies a threshold.

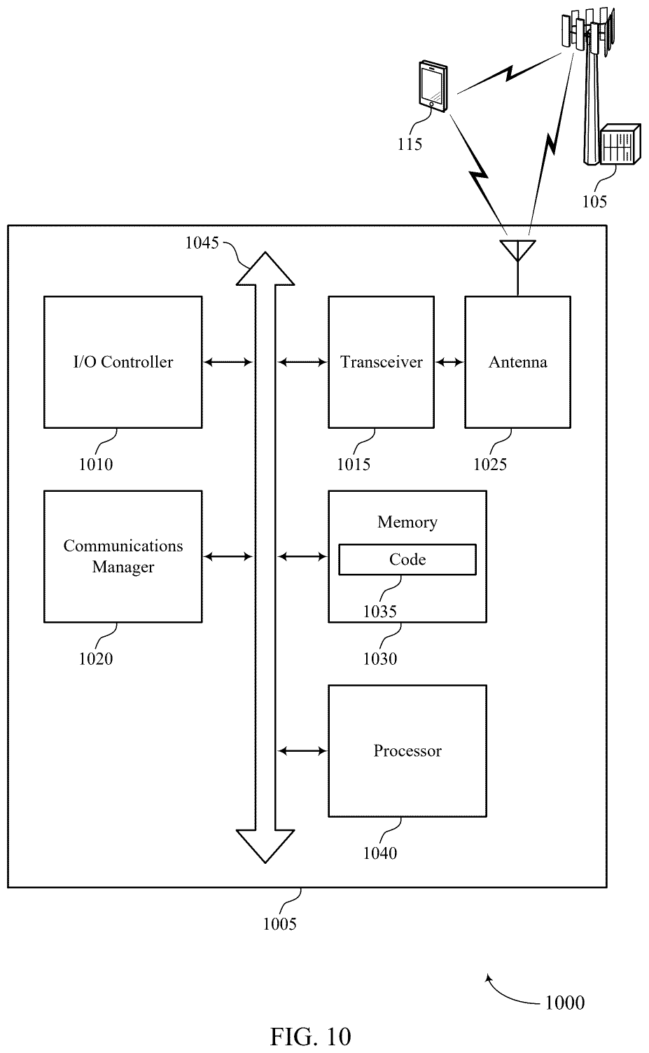

FIG. 10 shows a diagram of a system 1000 including a device 1005 that supports cyclic delay value reporting in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting cyclic delay value reporting). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communication in accordance with examples as disclosed herein. For example, the communications manager 1020 is capable of, configured to, or operable to support a means for receiving control signaling allocating one or more uplink resources. The communications manager 1020 is capable of, configured to, or operable to support a means for transmitting an indication of one or more cyclic delay values in accordance with receiving the control signaling, where each cyclic delay value of the one or more cyclic delay values corresponds to a delay between one or more instances of a signal, each instance of the signal transmitted via a respective antenna at the UE. The communications manager 1020 is capable of, configured to, or operable to support a means for transmitting one or more uplink signals in accordance with the one or more cyclic delay values, in accordance with the control signaling, or both.

By including or configuring the communications manager 1020 in accordance with examples as described herein, the device 1005 may support techniques for improved communication reliability, reduced latency, and more efficient utilization of communication resources.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of cyclic delay value reporting as described herein, or the at least one processor 1040 and the at least one memory 1030 may be otherwise configured to, individually or collectively, perform or support such operations.

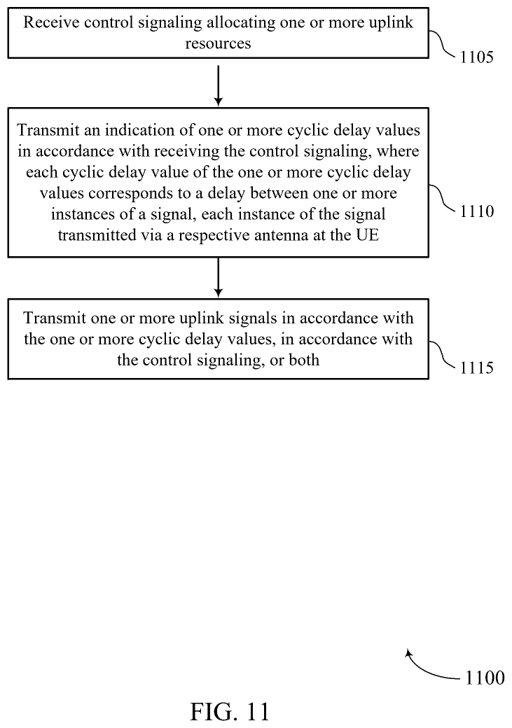

FIG. 11 shows a flowchart illustrating a method 1100 that supports cyclic delay value reporting in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include receiving control signaling allocating one or more uplink resources. The operations of 1105 may be performed in accordance with examples as disclosed herein. In some examples, aspects of the operations of 1105 may be performed by a control signaling manager 925 as described with reference to FIG. 9.

At 1110, the method may include transmitting an indication of one or more cyclic delay values in accordance with receiving the control signaling, where each cyclic delay value of the one or more cyclic delay values corresponds to a delay between one or more instances of a signal, each instance of the signal transmitted via a respective antenna at the UE. The operations of 1110 may be performed in accordance with examples as disclosed herein. In some examples, aspects of the operations of 1110 may be performed by a delay value indication manager 930 as described with reference to FIG. 9.

At 1115, the method may include transmitting one or more uplink signals in accordance with the one or more cyclic delay values, in accordance with the control signaling, or both. The operations of 1115 may be performed in accordance with examples as disclosed herein. In some examples, aspects of the operations of 1115 may be performed by an uplink signal manager 935 as described with reference to FIG. 9.

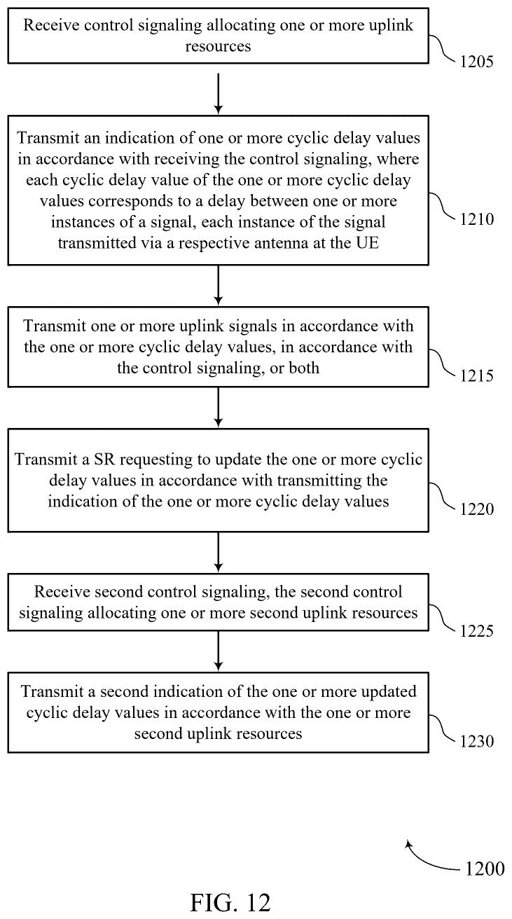

FIG. 12 shows a flowchart illustrating a method 1200 that supports cyclic delay value reporting in accordance with one or more aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1205, the method may include receiving control signaling allocating one or more uplink resources. The operations of 1205 may be performed in accordance with examples as disclosed herein. In some examples, aspects of the operations of 1205 may be performed by a control signaling manager 925 as described with reference to FIG. 9.

At 1210, the method may include transmitting an indication of one or more cyclic delay values in accordance with receiving the control signaling, where each cyclic delay value of the one or more cyclic delay values corresponds to a delay between one or more instances of a signal, each instance of the signal transmitted via a respective antenna at the UE. The operations of 1210 may be performed in accordance with examples as disclosed herein. In some examples, aspects of the operations of 1210 may be performed by a delay value indication manager 930 as described with reference to FIG. 9.

At 1215, the method may include transmitting one or more uplink signals in accordance with the one or more cyclic delay values, in accordance with the control signaling, or both. The operations of 1215 may be performed in accordance with examples as disclosed herein. In some examples, aspects of the operations of 1215 may be performed by an uplink signal manager 935 as described with reference to FIG. 9.

At 1220, the method may include transmitting an SR requesting to update the one or more cyclic delay values in accordance with transmitting the indication of the one or more cyclic delay values. The operations of 1220 may be performed in accordance with examples as disclosed herein. In some examples, aspects of the operations of 1220 may be performed by an SR manager 940 as described with reference to FIG. 9.

At 1225, the method may include receiving second control signaling, the second control signaling allocating one or more second uplink resources. The operations of 1225 may be performed in accordance with examples as disclosed herein. In some examples, aspects of the operations of 1225 may be performed by a control signaling manager 925 as described with reference to FIG. 9.

At 1230, the method may include transmitting a second indication of the one or more updated cyclic delay values in accordance with the one or more second uplink resources. The operations of 1230 may be performed in accordance with examples as disclosed herein. In some examples, aspects of the operations of 1230 may be performed by a delay value indication manager 930 as described with reference to FIG. 9.

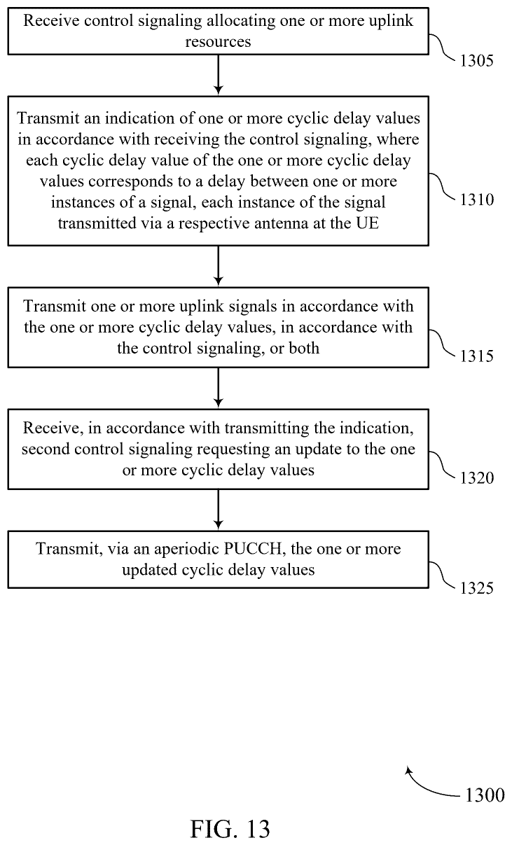

FIG. 13 shows a flowchart illustrating a method 1300 that supports cyclic delay value reporting in accordance with one or more aspects of the present disclosure. The operations of the method 1300 may be implemented by a UE or its components as described herein. For example, the operations of the method 1300 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1305, the method may include receiving control signaling allocating one or more uplink resources. The operations of 1305 may be performed in accordance with examples as disclosed herein. In some examples, aspects of the operations of 1305 may be performed by a control signaling manager 925 as described with reference to FIG. 9.

At 1310, the method may include transmitting an indication of one or more cyclic delay values in accordance with receiving the control signaling, where each cyclic delay value of the one or more cyclic delay values corresponds to a delay between one or more instances of a signal, each instance of the signal transmitted via a respective antenna at the UE. The operations of 1310 may be performed in accordance with examples as disclosed herein. In some examples, aspects of the operations of 1310 may be performed by a delay value indication manager 930 as described with reference to FIG. 9.

At 1315, the method may include transmitting one or more uplink signals in accordance with the one or more cyclic delay values, in accordance with the control signaling, or both. The operations of 1315 may be performed in accordance with examples as disclosed herein. In some examples, aspects of the operations of 1315 may be performed by an uplink signal manager 935 as described with reference to FIG. 9.

At 1320, the method may include receiving, in accordance with transmitting the indication, second control signaling requesting an update to the one or more cyclic delay values. The operations of 1320 may be performed in accordance with examples as disclosed herein. In some examples, aspects of the operations of 1320 may be performed by a control signaling manager 925 as described with reference to FIG. 9.

At 1325, the method may include transmitting, via an aperiodic PUCCH, the one or more updated cyclic delay values. The operations of 1325 may be performed in accordance with examples as disclosed herein. In some examples, aspects of the operations of 1325 may be performed by a PUCCH manager 945 as described with reference to FIG. 9.

The following provides an overview of aspects of the present disclosure:

Aspect 1: A method for wireless communication at a UE, comprising: receiving control signaling allocating one or more uplink resources; transmitting an indication of one or more cyclic delay values in accordance with receiving the control signaling, wherein each cyclic delay value of the one or more cyclic delay values corresponds to a delay between one or more instances of a signal, each instance of the signal transmitted via a respective antenna at the UE; and transmitting one or more uplink signals in accordance with the one or more cyclic delay values, in accordance with the control signaling, or both.

Aspect 2: The method of aspect 1, wherein the control signaling allocates one or more SRS resources, and each of the one or more SRS resources is associated with a respective MCS, a respective bandwidth, or both.

Aspect 3: The method of aspect 2, wherein transmitting the indication comprises: transmitting one or more SRSs via the one or more SRS resources, wherein each of the one or more SRSs is transmitted according to a respective cyclic delay value of the one or more cyclic delay values.

Aspect 4: The method of any of aspects 2 through 3, further comprising: receiving second control signaling activating or deactivating at least one SRS resource of the one or more SRS resources, wherein transmitting the indication of the one or more cyclic delay values is in accordance with the activation or the deactivation.

Aspect 5: The method of any of aspects 2 through 4, further comprising: receiving second control signaling overriding at least one SRS resource of the one or more SRS resources, wherein transmitting the indication of the one or more cyclic delay values is in accordance with overriding the at least one SRS resource.

Aspect 6: The method of any of aspects 2 through 5, wherein each cyclic delay value of the one or more cyclic delay values is associated with the respective MCS, the respective bandwidth, or both.

Aspect 7: The method of aspect 6, wherein at least one cycle delay value of the one or more cyclic delay values is associated with respective channel quality information for at least one SRS resource of the one or more SRS resources in accordance with an absence of an indication of a MCS for the at least one SRS resource.

Aspect 8: The method of aspect 1, wherein receiving the control signaling comprises: receiving DCI allocating the one or more uplink resources and requesting transmission of the one or more cyclic delay values, wherein transmitting the indication of the one or more cyclic delay values is in accordance with receiving the DCI.

Aspect 9: The method of aspect 8, wherein the DCI further indicates one or more MCSs, one or more bandwidths, or both associated with the one or more uplink resources, and each cyclic delay value of the one or more cyclic delay values is associated with a respective MCS, a respective bandwidth, or both.

Aspect 10: The method of any of aspects 8 through 9, wherein transmitting the indication comprises: transmitting a report indicating the one or more cyclic delay values via a PUCCH or via a MAC-CE.

Aspect 11: The method of any of aspects 1 through 10, further comprising: transmitting a SR requesting to update the one or more cyclic delay values in accordance with transmitting the indication of the one or more cyclic delay values; receiving second control signaling, the second control signaling allocating one or more second one or more uplink resources; and transmitting a second indication of the one or more updated cyclic delay values in accordance with the one or more second one or more uplink resources.

Aspect 12: The method of any of aspects 1 through 11, further comprising: receiving, in accordance with transmitting the indication, second control signaling requesting an update to the one or more cyclic delay values; and transmitting, via an aperiodic PUCCH, the one or more updated cyclic delay values.

Aspect 13: The method of any of aspects 1 through 12, wherein transmitting the one or more uplink signals is after a first duration from transmitting the indication of the one or more cyclic delay values.

Aspect 14: The method of any of aspects 1 through 13, wherein the one or more uplink signals comprise a PUCCH or a PUSCH.

Aspect 15: The method of any of aspects 1 through 14, wherein the one or more cyclic delay values comprise one or more small delay cyclic delay diversity values, and each small delay cyclic diversity value of the one or more small delay cyclic delay diversity values satisfies a threshold.

Aspect 16: A UE for wireless communication, comprising one or more memories storing processor-executable code, and one or more processors coupled with the one or more memories and individually or collectively operable to execute the code to cause the UE to perform a method of any of aspects 1 through 15.

Aspect 17: A UE for wireless communication, comprising at least one means for performing a method of any of aspects 1 through 15.

Aspect 18: A non-transitory computer-readable medium storing code for wireless communication, the code comprising instructions executable by one or more processors to perform a method of any of aspects 1 through 15.

It should be noted that the methods described herein describe possible implementations. The operations and the steps may be rearranged, or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling allocating one or more uplink resources;
transmit an indication of one or more cyclic delay values in accordance with receiving the control signaling, wherein each cyclic delay value of the one or more cyclic delay values corresponds to a delay between one or more instances of a signal, each instance of the signal transmitted via a respective antenna at the UE; and
transmit one or more uplink signals in accordance with the one or more cyclic delay values, in accordance with the control signaling, or both.

2. The UE of claim 1, wherein the control signaling allocates one or more sounding reference signal resources, and wherein each of the one or more sounding reference signal resources is associated with a respective modulation and coding scheme, a respective bandwidth, or both.

3. The UE of claim 2, wherein, to transmit the indication, the one or more processors are individually or collectively operable to execute the code to cause the UE to:
transmit one or more sounding reference signals via the one or more sounding reference signal resources, wherein each of the one or more sounding reference signals is transmitted according to a respective cyclic delay value of the one or more cyclic delay values.

4. The UE of claim 2, wherein the one or more processors are individually or collectively further operable to execute the code to cause the UE to:
receive second control signaling activating or deactivating at least one sounding reference signal resource of the one or more sounding reference signal resources, wherein transmitting the indication of the one or more cyclic delay values is in accordance with the activation or the deactivation.

5. The UE of claim 2, wherein the one or more processors are individually or collectively further operable to execute the code to cause the UE to:
receive second control signaling overriding at least one sounding reference signal resource of the one or more sounding reference signal resources, wherein transmitting the indication of the one or more cyclic delay values is in accordance with overriding the at least one sounding reference signal resource.

6. The UE of claim 2, wherein each cyclic delay value of the one or more cyclic delay values is associated with the respective modulation and coding scheme, the respective bandwidth, or both.

7. The UE of claim 6, wherein at least one cycle delay value of the one or more cyclic delay values is associated with respective channel quality information for at least one sounding reference signal resource of the one or more sounding reference signal resources in accordance with an absence of an indication of a modulation and coding scheme for the at least one sounding reference signal resource.

8. The UE of claim 1, wherein, to receive the control signaling, the one or more processors are individually or collectively operable to execute the code to cause the UE to:
receive downlink control information allocating the one or more uplink resources and requesting transmission of the one or more cyclic delay values, wherein transmitting the indication of the one or more cyclic delay values is in accordance with receiving the downlink control information.

9. The UE of claim 8, wherein:
the downlink control information further indicates one or more modulation and coding schemes, one or more bandwidths, or both associated with the one or more uplink resources, and
each cyclic delay value of the one or more cyclic delay values is associated with a respective modulation and coding scheme, a respective bandwidth, or both.

10. The UE of claim 8, wherein, to transmit the indication, the one or more processors are individually or collectively operable to execute the code to cause the UE to:
transmit a report indicating the one or more cyclic delay values via a physical uplink control channel or via a media access control-control element.

11. The UE of claim 1, wherein the one or more processors are individually or collectively further operable to execute the code to cause the UE to:
transmit a scheduling request requesting to update the one or more cyclic delay values in accordance with transmitting the indication of the one or more cyclic delay values;
receive second control signaling, the second control signaling allocating one or more second one or more uplink resources; and
transmit a second indication of the one or more updated cyclic delay values in accordance with the one or more second one or more uplink resources.

12. The UE of claim 1, wherein the one or more processors are individually or collectively further operable to execute the code to cause the UE to:
receive, in accordance with transmitting the indication, second control signaling requesting an update to the one or more cyclic delay values; and
transmit, via an aperiodic physical uplink control channel, the one or more updated cyclic delay values.

13. The UE of claim 1, wherein transmitting the one or more uplink signals is after a first duration from transmitting the indication of the one or more cyclic delay values.

14. The UE of claim 1, wherein the one or more uplink signals comprise a physical uplink control channel or a physical uplink shared channel.

15. The UE of claim 1, wherein:
the one or more cyclic delay values comprise one or more small delay cyclic delay diversity values, and
each small delay cyclic diversity value of the one or more small delay cyclic delay diversity values satisfies a threshold.

16. A method for wireless communication at a user equipment (UE), comprising:
receiving control signaling allocating one or more uplink resources;
transmitting an indication of one or more cyclic delay values in accordance with receiving the control signaling, wherein each cyclic delay value of the one or more cyclic delay values corresponds to a delay between one or more instances of a signal, each instance of the signal transmitted via a respective antenna at the UE; and
transmitting one or more uplink signals in accordance with the one or more cyclic delay values, in accordance with the control signaling, or both.

17. The method of claim 16, wherein:
the control signaling allocates one or more sounding reference signal resources, and
each of the one or more sounding reference signal resources is associated with a respective modulation and coding scheme, a respective bandwidth, or both.

18. The method of claim 16, wherein receiving the control signaling comprises:
receiving downlink control information allocating the one or more uplink resources and requesting transmission of the one or more cyclic delay values, wherein transmitting the indication of the one or more cyclic delay values is in accordance with receiving the downlink control information.

19. The method of claim 16, further comprising:
transmitting a scheduling request requesting to update the one or more cyclic delay values in accordance with transmitting the indication of the one or more cyclic delay values;
receiving second control signaling, the second control signaling allocating one or more second one or more uplink resources; and
transmitting a second indication of the one or more updated cyclic delay values in accordance with the one or more second one or more uplink resources.

20. A non-transitory computer-readable medium storing code for wireless communication at a user equipment (UE), the code comprising instructions executable by one or more processors to:
receive control signaling allocating one or more uplink resources;
transmit an indication of one or more cyclic delay values in accordance with receiving the control signaling, wherein each cyclic delay value of the one or more cyclic delay values corresponds to a delay between one or more instances of a signal, each instance of the signal transmitted via a respective antenna at the UE; and
transmit one or more uplink signals in accordance with the one or more cyclic delay values, in accordance with the control signaling, or both.
